(19) United States
(12) Patent Application Publication
(10) Pub. No.: US 2025/0257007 A1
(43) Pub. Date: Aug. 14, 2025

(54) HYDROGEL COMPOSITIONS FOR STABILIZATION OF CEMENTITIOUS COMPOSITIONS

(71) Applicant: Intelligent Concrete, LLC, Elbert, CO (US)

(72) Inventors: Jonathan S. Belkowitz, Howell, NJ (US); WhitneyLe B. Belkowitz, Howell, NJ (US); Mallory A. Westbrook, Howell, NJ (US)

(21) Appl. No.: 19/050,497

(22) Filed: Feb. 11, 2025

Related U.S. Application Data
(60) Provisional application No. 63/552,231, filed on Feb. 12, 2024.

(51) Int. Cl. C04B 14/06; C04B 20/10; C04B 22/12; C04B 28/02; C04B 40/00; C04B 103/10

(52) U.S. Cl. CPC C04B 14/062; C04B 20/1066; C04B 22/124; C04B 28/02; C04B 40/0039; C04B 2103/10

(57) ABSTRACT

A composition including colloidal nanosilica particles, an activator salt, and water, wherein the composition is, or forms, a hydrogel structure. Methods of stabilizing cementitious compositions include adding compositions including colloidal nanosilica particles, an activator salt, and water to the cementitious composition.

### CROSS-REFERENCE TO RELATED APPLICATIONS

This application claims priority to and the benefit of U.S. Provisional Patent App. No. 63/552,231, filed Feb. 12, 2024, the contents of which are incorporated herein by reference in their entirety.

### FIELD

The present technology is generally related to compositions for stabilizing technologies meant for concrete and other cementitious composites. More specifically, the technology is related to compositions for addition to a concrete mixture.

### BACKGROUND

Many state of the art technologies in the cement industry designed to address phase separation in cementitious composites. Such technologies use a variety of emulsifying agents or other types of stabilizing agents that hold the liquid in a narrow pH balance. If the balance of the chemical or physical characteristics are disrupted, the liquid suspension destabilizes and phase separation results. Accordingly, despite these other technologies, the industry still needs stabilization agents to minimize or avoid separation of cementitious compositions.

### SUMMARY

In one aspect, a composition is provided that include colloidal nanosilica particles, an activator salt, and water, wherein the composition is, or forms, a hydrogel structure.

In another aspect, a method of treating a freshly mixed cementitious composite is provided, the method includes adding a composition that includes colloidal nanosilica particles, an activator salt, and water, wherein the composition is, or forms, a hydrogel structure to the freshly mixed cementitious composite in a vessel.

In general, the colloidal silica is a water dispersion that is a nanosilica-based hydrogel. The technology is mixed with the nano silica as described herein, where the mixing of the nano silica with the technology functionalizes the technology to both coat and anchor into the technology with the nano silica. After mixing the technology and the nano silica until a well-mixed dispersion is reached, the salt activator is added to turn the liquid dispersion with a viscosity of 50,000 to 200,000 centipoise (cps).

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, hydrogels are a network of polymer chains that attract water (i.e., they are hydrophilic). The hydrogels of the present technology are based upon polymer like networks of colloidal nanosilica supported in an aqueous medium.

The present inventors have surprisingly found that colloidal nanosilica-based hydrogels are able to positively impact of the stability of cement pore solutions, and allow for the introduction of other additives to cementitious compositions. When mixed with cementitious compositions, such as a simulated-cement pore solution, admixtures that include colloidal nanosilica and an activator salt start to build a hydrogel network in and around the cement and aggregate to stabilize the cementitious composites against phase separation. The hydrogels also retain pore-water within the structure to aid in curing of the cementitious compositions. The hydrogels also help to block ion transport (i.e., transport of chlorides and other impurities) within the cementitious composition that would compromise both the forming concrete, and, if present, the reinforcing steel.

The colloidal nanosilica-based hydrogels provide a viable technology for reducing the permeability and increasing the durability of concrete structures, and provide water reservoirs for internal curing. The addition of the colloidal nanosilica admixtures described herein to cementitious composites have the ability to (a) reduce the tendency for phase separation due to time and or temperature variations, (b) functionalize surfaces of the colloidal nanosilica particles with coatings to provide desirable mechanical and chemical properties, (c) increase the solid content and reduce the water content of the cementitious composites during shipping (i.e. substantially reducing costs), and (d) provide a water reservoir for later age curing in a similar manner to light weight aggregates.

In one aspect, a composition is provided that includes colloidal nanosilica particles, an activator salt, and water. Upon mixing of the colloidal nanosilica particles and the activator salt, along with any other additive ingredients, the composition forms a hydrogel structure. The rate at which hydrogel formation occurs is dependent upon temperature, concentration, and other additives that are present. For example, the temperature may be from −20° C. to 95° C., or from 0° C. to 80° C., or from greater than 0° C. to 50° C.

The colloidal nanosilica particles may be of a variety of sizes and shapes. For example, in some embodiments, the colloidal nanosilica particles as used in the composition have a particle size from about 1 nm to about 1000 nm. This can include particles sizes from about 10 nm to about 500 nm; from about 10 nm to about 100 nm; from about 10 nm to about 50 nm; and from about 10 nm to about 45 nm. The colloidal nanosilica particles may have a shape that is spherical, elliptical, cylindrical, or irregular. The type of shape used is normally spherical for the embodiments but particle size changes to elliptical or elongated as the particles become larger.

The colloidal nanosilica particles may be present in the compositions at a concentration such that the hydrogels that form have desirable properties. For example, lower compositions will form less viscous hydrogels, while higher concentrations will form more robust hydrogel structures. In various embodiments, the colloidal nanosilica particles may be present in the composition from about 1 wt % to about 50 wt % of the total weight of the composition. In some embodiments, the colloidal nanosilica particles may be present in the composition at greater than about 25 wt %. In some embodiments, the colloidal nanosilica particles may be present in the composition from about 20 wt % to about 50 wt % of the total weight of the composition.

The pH of the nanosilica can range from acidic (less than 4 and up to 7), neutral (7), to basic (7 and above). The pH of these nanosilica topical treatments without additions listed above should not exceed 10.7.

As noted above, the colloidal nanosilica particles may be coated to provide functionalization or other properties to the hydrogels. For example, the colloidal nanosilica particles may be at least partially coated with alumina, silicon (silane), copper, titanium dioxide for the purpose of acting as a buffer between any reactions that would go on between the technology and the nano silica sized particles or in cases of the copper coating, enhancing additives to reduce microbial induced corrosion, or the like.

The compositions also include an activator salt. The salt is used to drive the formation of the hydrogel from the colloidal nanosilica particles in the aqueous medium. Without being bound by theory, it is believed that this occurs because the nano silica particles in the colloidal dispersion are kept in suspension based on particles not sticking to each other as a result of the development of Van der waal forces (VDWF). The electrical double layer on the surface of the nano silica in suspension, keeps the VDWFs from developing and the particles sticking together. The addition of technology to this dispersion colloidal silica should not affect the electrical double potential at the nano silica nor should it impact the electro-negative potential of the dispersion, if so another colloidal silica (less reactive, coated) should be selected. The salt is added to disrupt the electro-negative potential of the solution. This disruption causes the nano silica particles to start developing VDWFs and sticking together in different three-dimensional geometries. These geometries, in the form of nano silica-based hydrogels, trap the water as well as the technology in a dispersible form Illustrative activator salts may include, but are not limited to, NaCl, KCl, CaCl₂, MgCl₂, KI, NaHCO₃, calcium silicate, tricalcium phosphate, or a mixture of any two or more thereof. In some embodiments, the activator salt includes NaCl and KI.

The activator salt(s) may be present in the composition from about 2.5 to about 2% percent solids by weight of total solution. In some embodiments, the activator salt(s) may be present in the composition from about 5 to about 8 percent solids by weight of total solution.

The compositions may also include other additives to impart certain properties to the colloidal nanosilica hydrogels, or the finished concrete. For example, the compositions may also include other surfactants, silicates, titanium dioxide, nano clays, dispersants, polymers, or a combination of any two or more thereof.

In another aspect, a method for stabilizing cementitious composites is provided, the method including treating, in a vessel, an uncured (or freshly mixed) cementitious composition with any of the colloidal nanosilica particle compositions as described herein. The treating may include injecting the colloidal nanosilica particle compositions into a cementitious composition such as cement, cement-aggregate composites, mortar, or other materials. The treating may be done in any vessel in which cementitious compositions are prepared. For example, in a bucket, a tote, a tank, a concrete mixing truck, a tilting concrete mixer, a non-tilting concrete mixer, a reversing drum mixer, or a pan-type mixer.

The methods may include adding the colloidal nanosilica admixture into the cementitious composite, and mixing the resulting composition. This may be conducted at the point of the initial mixing of the cementitious composite, during dwell time, or at the point of pouring or application. The composition may include colloidal nanosilica particles in an aqueous suspension, and the concrete slurry comprises an aqueous suspension of uncured concrete, that may include freshly mixed concrete, mortar, grout or the like.

In another aspect, a method for stabilizing cementitious composites is provided, the method including treating, in a vessel, an uncured (or freshly mixed) cementitious composition with a mixture of colloidal nanosilica particles with an activator salt. This may be without the addition of water, where a cementitious composition, prior to water addition, is mixed with the colloidal nanosilica particles and activator salt, such that upon water addition and mixing, the hydrogel formation is initiated as part of an overall cementitious composition.

The composition(s) may be present in the concrete batch (or any other cementitious composite) from about 0.50 to 175.00 fluid ounces per cementitious hundred weight. In some embodiments, the composition(s) may be present in the concrete from about 7.50 and 30.00 fluid ounces per cementitious hundred weight.

The present invention, thus generally described, will be understood more readily by reference to the following examples, which are provided by way of illustration and are not intended to be limiting of the present invention.

### EXAMPLES

Example 1. Suspension. The colloidal nanosilica is combined with water and suspended in a vessel by stirring with a propellor-type blade or magnetic stirrer at a rate of about 600 revolutions per minute (RPM) up to (an in some cases greater than) 10,000 RPM. The technology can be mixed with the colloidal silica for 2 minutes to 180 minutes (in some cases shorter or longer). The greater the need for a breaking down of the suspended materials the longer the mixing time, and the higher the stirring rate. In cases where breaking down of the material is not needed, a magnetic stirrer or equivalent can be used.

Activation. After mixing of the colloidal silica for the time and method described above, a 5% solids content salt solution was mixed into the colloidal silica—technology blend. The mixture was blended with the salt activator at 600 revolutions per minute (RPM) up to (an in some cases greater) 10,000 RPM. The technology can be mixed with the colloidal silica for 2 minutes to 180 minutes (in some cases shorter or longer).

TABLE 1
Colloidal Silica Hydrogel Mixtures Percent (%) Breakdown
of Solutions without additional technologies.

| | | | Salt/15 to | | Salt/45 to | |
|---|---|---|---|---|---|---|
| | Salt/3 to 5 | | 17 nm | | 47 nm | |
| Materials/ | nm colloidal | Solids | colloidal | Solids | colloidal | Solids |
| Mix ID | silica | Content (%) | silica | Content (%) | silica | Content (%) |
| Salt 1 | 25/75 | 13.1 | 25/75 | 24.4 | 25/75 | 39.4 |
| | 50/50 | 11.10 | 50/50 | 18.8 | 50/50 | 28.8 |
| | 75/25 | 9.40 | 75/25 | 13.1 | 75/25 | 18.1 |
| Salt 2 | 25/75 | 15.0 | 25/75 | 26.3 | 25/75 | 41.3 |
| | 50/50 | 15.0 | 50/50 | 22.5 | 50/50 | 32.5 |
| | 75/25 | 15.0 | 75/25 | 18.8 | 75/25 | 23.8 |

In Tables 1 and 2, Salt 1 is a mixture of NaCl and KI (50:1) at 7.5 wt % in the hydrogel mixture; and salt 2 is a mixture of NaCl and KI (50:1) at 15 wt % in the hydrogel mixture. Other ratios of NaCl and KI (as well as other salt types: MgCl, LiSiO₃) can also be used depending on the need of the size, specific gravity, electrical surface charge and surface area of the additional technology.

TABLE 2
Colloidal Silica Hydrogel Mixtures Percent (%) Breakdown
of Solutions with additional technologies, Titanium Dioxide
Powder, 45-65 um with Specific Gravity of 2.90.

| | | TiO₂ Powder, 45- | |
|---|---|---|---|
| | Salt/15 to 17 | 65 um (% | Solids |
| Materials/Mix | nm colloidal | Addition to Total | Content |
| ID | silica | Formula) | (%) |
| Salt 1 | 25/75 | 5 | 31.30 |
| | 50/50 | 5 | 27.50 |
| | 75/25 | 5 | 18.10 |
| | 25/75 | 10 | 36.30 |
| | 50/50 | 10 | 32.50 |
| | 75/25 | 10 | 28.80 |

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A composition comprising colloidal nanosilica particles, an activator salt, and water, wherein the composition is, or forms, a hydrogel structure.

2. The composition of claim 1, wherein the colloidal nanosilica particles have a particle size from about 1 nm to about 1000 nm.

3. The composition of claim 2, wherein the colloidal nanosilica particles have a particle size from about 10 nm to about 45 nm.

4. The composition of claim 1, wherein the colloidal nanosilica particles have a shape that is spherical, elliptical, cylindrical, or irregular.

5. The composition of claim 1, wherein the colloidal nanosilica particles are present from about 1 wt % to about 50 wt % of the total weight of the composition.

6. The composition of claim 1, wherein the colloidal nanosilica particles are coated.

7. The composition of claim 6, wherein the colloidal nanosilica particles are at least partially coated with alumina.

8. The composition of claim 1, wherein the activator salt comprises NaCl, KCl, CaCl₂, MgCl₂, KI, NaHCO₃, calcium silicate, tricalcium phosphate, or a mixture of any two or more thereof.

9. The composition of claim 8, wherein the activator salt comprises a mixture of NaCl and KI.

10. The composition of claim 1 further comprising a nonaqueous solvent, a surfactant, a silicate, a degreaser, a dispersant, a polymer, or a combination of any two or more thereof.

11. A method of treating a freshly mixed cementitious composite, the method comprising adding the composition of claim 1 to the freshly mixed cementitious composite in a vessel.

12. The method of claim 11, wherein the vessel is a bucket, a tote, a tank, a concrete mixing truck, a tilting concrete mixer, a non-tilting concrete mixer, a reversing drum mixer, or a pan-type mixer.
